(19) United States
(12) Patent Application Publication
(10) Pub. No.: US 2014/0132125 A1
(43) Pub. Date: May 15, 2014

(54) ELECTRICAL MACHINE COMPRISING A SAFETY CIRCUIT

(71) Applicant: ROBERT BOSCH GMBH, Stuttgart (DE)

(72) Inventors: Vincent Rieger, Karlsruhe (DE); Martin Neuburger, Geislingen (DE)

(73) Assignee: ROBERT BOSCH GMBH, Stuttgart (DE)

(21) Appl. No.: 14/129,744

(22) PCT Filed: May 22, 2012
(86) PCT No.: PCT/EP2012/059475

§ 371 Date: Feb. 3, 2014

(30) Foreign Application Priority Data
Jun. 28, 2011 (DE) 10 2011 078 158.7

(51) Int. Cl. H02K 11/00

(52) U.S. Cl. CPC H02K 11/0057
USPC 310/68 C

(57) ABSTRACT

The invention relates to an electrically excited machine (2), in particular for use in a steering system of a motor vehicle, comprising: a stator with a stator winding having multiple phases; an exciter winding (3) which is arranged so as to couple an excitation magnetic field into a rotor that is movably disposed relative to the rotor so that a magnetic field is generated in an air gap between the stator and the rotor; and an exciting circuit having a fuse (11) which is automatically triggered in the event of an overcurrent.

### BACKGROUND OF THE INVENTION

The present invention relates to electrical machines, in particular electrically excited electrical machines, such as machines with hybrid excitation or external excitation for example. In particular, the present invention relates to electrically excited electrical machines for use in steering systems and, in particular, measures for reducing a braking torque which occurs in the event of a fault.

Electrical machines with external excitation or hybrid excitation require two further electrical contact-making means for the field winding in comparison to machines with permanent-magnet excitation. The field winding usually has to be actuated by a dedicated actuation unit, a field circuit.

As an alternative, the field winding can also be supplied with current by means of the driver circuit which operates the winding phases of the electrical machine. In this case, the field winding is connected between a star point, by means of which the winding phases of the electrical machine are connected to one another, and a ground potential.

In the event of a breakdown of the driver circuit, it is necessary to prevent the electrical machine from building up an electrical braking torque in addition to its mechanical running difficulties owing to the loss of the assistance torque.

In the event of a fault, it is necessary, depending on the type of fault, for example in the case of a broken-down pull-up switch, to further actuate an individual switch in order to implement a steering-assisted driving-home aid or, as an alternative, to provide a phase relay and/or star point relay which can be disconnected.

Particularly when the field winding is connected between a star point in the electrical machine and a ground potential, a fault may even lead to overexcitation, by means of which a high braking torque would be generated. When an electrical machine of this kind is used in a steering system, this can lead to an inability to steer a vehicle and therefore constitutes a safety risk.

Owing to the excitation magnets, which are present in the electrical machine with hybrid excitation in addition to the field winding, in the event of a short-circuit fault in the driver circuit, the permanent magnets present in the electrical machine can generate an induced voltage which runs freely across the short-circuited switch, generates a current flow and as a result exerts an electrical braking torque which counteracts the external torque. This fault is particularly critical for an electrical machine with hybrid excitation and a tap of the field winding at the star point since, in this case, the star point voltage is increased owing to the fault and the maximum excitation or an overexcited state can be produced.

Measures for disconnecting the star point of the electrical machine in the event of a fault occurring are generally complex since a special switch, for example a star point relay, is required for this purpose.

The object of the present invention is therefore to provide a safety concept for an electrically excited electrical machine, which safety concept allows the braking torque which may possibly occur in the event of a fault to be reduced in a simple manner.

### SUMMARY OF THE INVENTION

This object is achieved by the electrically excited electrical machine for use in a steering system , and also by the motor system according to the invention.

An electrically excited electrical machine, in particular for use in a steering system in a motor vehicle, is provided according to a first aspect. The machine comprises:
a stator having a stator winding which has a plurality of winding phases;
a rotor which is at least partially provided with soft-magnetic material and is arranged such that it can move in relation to the stator;
a field winding which is arranged so as to couple an excitation magnetic field into the rotor, so that a magnetic field is formed in an air gap between the stator and the rotor;
a field circuit which has a fuse which trips automatically in the event of an overcurrent.

One concept of the above electrical machine is that of providing the field winding with a separate fuse which trips automatically in the event of an overcurrent owing to a fault. Therefore, the field circuit can be reliably disconnected in the event of a fault independently of the supply of power via the winding phases, so that an undesirable braking torque cannot occur in the event of a fault. For this reason, an electrical machine of this kind with external excitation or hybrid excitation and with a fuse of this kind is particularly suitable for use in steering systems and other safety-critical devices in which a braking torque must not be exerted by the electrical machine in the event of a fault.

Furthermore, the fuse can have a fusible link.

According to one embodiment, the field winding, the field circuit and the fuse can be arranged on or in a housing of the electrical machine.

Provision can be made for the field circuit to be connected to a star point by means of which the winding phases are interconnected.

Furthermore, a driver circuit for supplying the phase currents through the winding phases of the electrical machine can be provided, wherein the driver circuit can be actuated by a control unit.

The control unit can be designed in order to detect a fault and, after the fault is detected, in order to actuate the driver circuit such that a high supply potential is permanently applied to one of the winding phases, so that the potential at a star point, by means of which the winding phases are interconnected, rises and increases the current flow through the field circuit.

Furthermore, the fuse can be designed in order to trip in the event of the increased current flow through the field circuit.

A motor system is provided according to a further aspect. The motor system comprises:
the above electrical machine;
a driver circuit for supplying current to the winding phases of the electrical machine; and
a control unit for actuating the driver circuit.

A method for operating the above motor system is provided according to a further aspect, wherein, after a fault is detected, a high supply potential is permanently applied to one of the winding phases, so that the potential at a star point, by means of which the winding phases are interconnected, rises and increases the current flow through the field circuit.

In particular, the fuse can be tripped in the event of the increased current flow through the field circuit.

### BRIEF DESCRIPTION OF THE DRAWINGS

Preferred embodiments of the present invention will be explained in greater detail below with reference to the appended drawing, in which:

FIG. 1 shows a schematic illustration of a motor system comprising an electrical machine with external excitation according to one embodiment.

### DETAILED DESCRIPTION

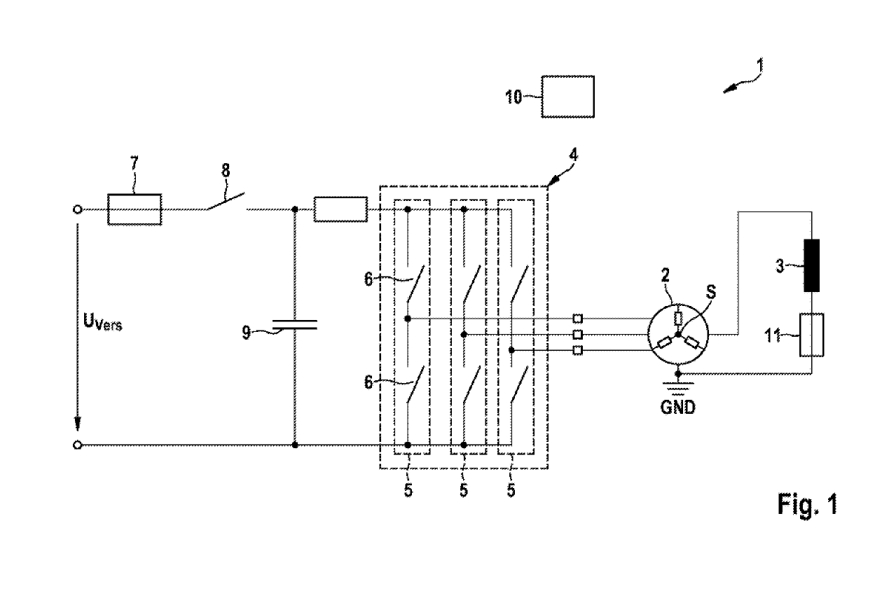

FIG. 1 shows a motor system 1 comprising an electrical machine 2 which, in the present case, is of three-phase design. The electrical machine 2 has a stator arrangement with three winding phases which are interconnected by means of a star point S to form a star point circuit.

The rotor (not shown) of the electrical machine 2 is formed from soft-magnetic material and an excitation magnetic field, which has substantially the same function as the permanent magnets in the rotor of a synchronous machine, is applied to said rotor by a field winding 3 which is arranged in a stationary manner. The field winding 3 is usually designed inside the stator, so that the excitation magnetic field enters the rotor and is deflected there, so that a magnetic field which serves to drive the rotor is formed in an air gap between rotor poles of the rotor and the stator.

In order to supply a current to the circuit which is formed with the field winding 3, the field winding 3 is connected between the star point S, by means of which the winding phases of the stator are connected to one another, and a ground potential GND in the exemplary embodiment shown.

The electrical machine 2 is further operated by a driver circuit 4 which is in the form of a B6 circuit. A B6 circuit has three inverter circuits 5, each with two semiconductor switches 6 which are connected in series and between which a node is provided in each case as a tap for the connection of one of the winding phases of the electrical machine 2. The semiconductor switches 6 are switched with the aid of a control unit 10, usually in accordance with a commutation scheme. The voltage which is applied to the driver circuit 4 is applied across each of the inverter circuits 5. An intermediate circuit capacitor 9 across which the supply voltage U_{Vers} is applied is also provided.

A supply voltage U_{Vers} between a high supply potential V_{H} and a low supply potential V_{L} is applied to the driver circuit 4, said supply voltage being connected to the driver circuit 4 via a first fuse 7 and a switching relay 8 which is connected in series with said fuse. The first fuse 7 is dimensioned such that a maximum current which flows through two winding phases of the electrical machine 2 when the entire supply voltage U_{Vers} is applied is still not sufficient to trip the fuse. The tripping threshold is preferably defined depending on this maximum current and a prespecified tolerance. In the event of a short circuit occurring between the high supply potential V_{H} and a low supply potential V_{L}, in particular in the event of a short circuit occurring through one of the inverter circuits 5 such that current flow through the winding phases is avoided, the first fuse 7 trips on account of the low resistance of the short-circuit path.

A second fuse 11 is provided in the field circuit, said second fuse being designed such that it avoids overexcitation. In particular, the second fuse 11 can be designed such that it can carry a current which is produced in the event of half a supply voltage U_{Vers} through the field circuit. The half supply voltage U_{Vers}/2 is applied to the star point S of the electrical machine 2 during normal operation. The second fuse 11 trips as soon as the current intensity in the field circuit clearly, for example in a tolerance range of 10%, exceeds this value. This can result in the field winding 3 being deactivated, so that a braking torque can no longer be produced.

If the field winding 3 is located in an electrical machine with hybrid excitation, at least the braking torque can be reduced to the effect of the permanent magnets in the rotor of the electrical machine 2 as a result. In addition, overexcitation which occurs owing to any increase in the star point voltage and which could lead to an additional braking torque can be prevented in this way.

The winding phases and the field winding 3 are preferably arranged in the electrical machine 2. For this reason, it is expedient to also arrange the second fuse 11 in the interior of the electrical machine 2. The first fuse 7 and/or the second fuse 11 are preferably in the form of fusible links and, in particular, in the form of fuses which produce automatic and permanent tripping, that is to say opening of the circuit which is to be protected.

Providing the second fuse 11 in the field circuit can implement a safety function which implements a safe state and completely disconnects the motor system 1 completely independently of the rest of the motor system 1 in the event of a fault. Owing to the ability of the field circuit to be disconnected independently, significant additional measures within the control electronics system are not required.

Provision can further be made for one of the winding phases to be connected to a high supply potential V_{H} over a relatively long period of time or permanently by means of the control unit 10 by actuating one of the semiconductor switches 6 which is connected to the high supply potential V_{H} in order to thereby raise the star point voltage. It is therefore possible, when a fault having occurred is identified, to trip the second fuse 11 by corresponding actuation of the semiconductor switches 6 of the driver circuit 4.

1. An electrically excited electrical machine (2), comprising:
a stator having a stator winding with a plurality of winding phases;
a field winding (3) configured to couple an excitation magnetic field to a rotor configured to move in relation to the stator, so that a magnetic field is formed in an air gap between the stator and the rotor; and
a field circuit which has a fuse (11) which trips automatically in the event of an overcurrent.

2. The electrical machine (2) as claimed in claim 1, wherein the fuse (11) has a fusible link.

3. The electrical machine (2) as claimed in claim 1, wherein the field winding, the field circuit and the fuse (11) are arranged on a housing of the electrical machine (2).

4. The electrical machine (2) as claimed in claim 1, wherein the field circuit is connected to a star point (S) by which the winding phases are interconnected.

5. The electrical machine (2) as claimed in claim 1, further comprising a driver circuit (4) for supplying the phase currents through the winding phases of the electrical machine (2), wherein the driver circuit (4) is actuated by a control unit (10).

6. The electrical machine (2) as claimed in claim 5, wherein the control unit (10) is configured to detect a fault and, after the fault is detected, to actuate the driver circuit (4) such that a high supply potential is continuously applied to one of the winding phases, so that the potential at a star point (S), by which the winding phases are interconnected, rises and increases the current flow through the field circuit.

7. The electrical machine (2) as claimed in claim 6, wherein the fuse (11) is designed in order to trip in the event of the increased current flow through the field circuit.

8. A motor system (1) comprising:
an electrical machine (2) as claimed in claim 1;
a driver circuit (4) for supplying current to the winding phases of the electrical machine (2);
a control unit (10) for actuating the driver circuit (4).

9. A method for operating a motor system (1) as claimed in claim 8, wherein, after a fault is detected, a high supply potential is permanently applied to one of the winding phases, so that the potential at a star point (S), by which the winding phases are interconnected, rises and increases the current flow through the field circuit.

10. The method as claimed in claim 9, wherein the fuse (11) is tripped in the event of the increased current flow through the field circuit.

11. The electrical machine (2) as claimed in claim 1, wherein the electrical machine is used in a steering system of a motor vehicle.

12. The electrical machine (2) as claimed in claim 1, wherein the field winding, the field circuit and the fuse (11) are arranged in a housing of the electrical machine (2).

13. The electrical machine (2) as claimed in claim 1, wherein the field winding, the field circuit and the fuse (11) are arranged on or in a housing of the electrical machine (2).
